(19) United States
(12) Patent Application Publication
(10) Pub. No.: US 2009/0290019 A1
(43) Pub. Date: Nov. 26, 2009

(54) SYSTEM, METHOD AND COMPUTER PROGRAM PRODUCT FOR INTEGRATION OF SENSOR AND WEAPON SYSTEMS WITH A GRAPHICAL USER INTERFACE

(75) Inventors: Niall B. McNelis, Sparks Glencoe, MD (US); William M. Tang, Elkridge, MD (US)

Correspondence Address: VENABLE LLP, P.O. BOX 34385, WASHINGTON, DC, 20043-9998, US

(73) Assignee: AAI Corporation, Hunt Valley, MD (US)

(21) Appl. No.: 12/392,786

(22) Filed: Feb. 25, 2009

Related U.S. Application Data
(60) Provisional application No. 61/064,265, filed on Feb. 25, 2008.

(51) Int. Cl. H04N 7/18; G06F 3/048

(52) U.S. Cl. 348/143; 715/764; 348/E07.085

(57) ABSTRACT

A system, method and computer program product provides for integrating a sensor system data and a weapon system data with a graphical user interface (GUI) is provided. An area surrounding the mobile object on the GUI system is displayed. The respective locations of one or more sensed objects sensed by the sensor system in the area may be determined in response to a user selected sensor system input. The one or more sensed objects on the GUI system may be displayed. The weapon system may be targeted upon the one or more sensed objects in response to a user selected weapon system input.

### CROSS-REFERENCE TO RELATED APPLICATIONS

The present application claims the benefit of U.S. Provisional Patent Application No. 61/064,265, filed Feb. 25, 2008, entitled “System, Method and Computer Program Product for Enemy Combatant Location and Weapon Control.”

### BACKGROUND

1. Field

The present invention relates generally to sensory and weapon systems control, and more particularly to integration of sensory and weapon systems with a graphical user interface.

2. Related Art

When military personnel are enclosed in military vehicles such as, but not limited to, High Mobility Multipurpose Wheeled Vehicle (HMMWVs), tanks, Strykers, assorted combat vehicles, etc., and the like, their vision of their surroundings may be hampered. In the case of the HMMWV, for example, there may be provided a remote weapon that has a bore-sighted camera mounted on it, allowing the personal a very limited view of the surroundings, providing them with imagery of where the weapon is pointed. In addition, the bore-sighted camera may provide a field of vision of as little as ±14° and possibly as little as ±2°. Such narrow field of vision is not nearly enough for the personal to be fully aware and alert of their surroundings.

Further, when military personnel are under attack from, for example by an enemy sniper, it may not be safe for the personnel to physically man a machine gun or other weapon provided with the vehicle. In particular, it is unsafe for the personnel to rely merely on eyesight to locate the enemy combatants. What is needed is a system that allows accurately sensing of targets and events, and controlling of weapon systems, in an integrated, wide interface.

### BRIEF DESCRIPTION OF THE DRAWINGS

The foregoing and other features and advantages of the invention will be apparent from the following, more particular description of exemplary embodiments of the invention, as illustrated in the accompanying drawings. In the drawings, like reference numbers generally indicate identical, functionally similar, and/or structurally similar elements. The drawing in which an element first appears is indicated by the leftmost digits in the corresponding reference number. A preferred exemplary embodiment is discussed below in the detailed description of the following drawings:

FIG. 1 illustrates an exemplary military vehicle equipped with exemplary sensor systems and/or weapon systems in accordance with certain embodiments;

FIG. 2 illustrates an exemplary military vehicle equipped with alternative exemplary sensor systems and/or weapon systems in accordance with certain embodiments;

FIG. 3 illustrates an exemplary camera system which may be used with the exemplary military vehicle in exemplary embodiments;

FIG. 4 illustrates an exemplary graphical user interface which may be used in accordance with exemplary embodiments; and

FIG. 5 illustrates a first exemplary diagram for calculating range of an object using a pixel shifting method;

FIG. 6 illustrates a second exemplary diagram for calculating range of an object using a pixel shifting method;

FIG. 7 illustrates an exemplary embodiment of a computer system that may be used in association with, in connection with, and/or in place of certain components in accordance with the present embodiments; and

FIG. 8 illustrates an exemplary embodiment of a control system that may be used in association with, in connection with, and/or in place of exemplary embodiments.

### SUMMARY

In an exemplary embodiment a system, method and computer program product for integrating sensory data and weaponry data with a graphical user interface (GUI) system of a mobile object is provided. The system may include: a camera system capturing an area surrounding the mobile object; a sensor system capturing the respective locations of one or more sensed objects in the area surrounding the mobile object in response to a user selected sensor system input; a weapon system targeting the one or more sensed objects in response to a user selected weapon system input, where the GUI system may display the area surrounding the mobile object and the one or more sensed objects in the area surrounding the mobile object.

The mobile object may be a military vehicle. The military vehicle may include any one of: a high mobility multipurpose vehicle (HMMWV); a tank; and an eight-wheeled all-wheel-drive armored combat vehicle.

The camera system may include a first camera system assembly displaying a front portion of the surrounding area of the mobile object, and a second camera system assembly displaying a rear portion of the surrounding area of the mobile object.

The sensor system may include at least one of: an acoustic detection system; an infrared (IR) detection system; a visible light detection system; a radar detection system; a microwave detection system; and a chemical detection system.

In an exemplary embodiment, the weapon system may include a lethal force producing weapon system. In another exemplary embodiment, the weapon system may include a non-lethal force producing weapon system, including any one of: a non-lethal laser system; a non-lethal radar system; and a non-lethal acoustic system.

The one or more sensed objects may include enemy combatants. The GUI system may be responsive to any one of: the user selected sensor system input and the user selected weapon system input.

Any one of the user selected sensor system input, and the user selected weapon system input, may include any one of: a touch-screen input, a mouse input, and a keyboard input.

An inertial navigation system for providing a location of the mobile object may be further included. In addition, a global positioning system (GPS) based navigation system for providing a location of the mobile object may also be included.

The GUI system may display the coordinates of the mobile object. The GUI system may display the coordinates of the one or more sensed objects.

In addition, a video recording system may be included for recording a video of the one or more sensed objects. In an exemplary embodiment, the video recording system may rewind the video recording and the GUI system may display the one or more sensed objects during a replay of a segment of the video recording.

An exemplary method for the present embodiments may be directed to integrating a sensor system data and a weapon system data with a graphical user interface (GUI) system of a mobile object. The method may include: displaying an area surrounding the mobile object on the GUI system; determining the respective locations of one or more sensed objects sensed by the sensor system in the area in response to a user selected sensor system input; displaying the one or more sensed objects on the GUI system; and targeting the weapon system upon the one or more sensed objects in response to a user selected weapon system input.

In an exemplary embodiment, the area surrounding the mobile object may be sensed by a camera system. The area surrounding the mobile object may include any one of: a 180 degree panoramic view of the front of the mobile object; a 180 degree panoramic view of the rear of the mobile object; and a 360 degree panoramic view of the surroundings of the mobile object.

The sensor system may detect at least one of: an acoustic signal associated with the sensed objects; an infrared (IR) signal associated with the sensed objects; a visible light signal associated with the sensed objects; a radar signal associated with the sensed objects; a microwave signal associated with the sensed objects; and a chemical signal associated with the sensed objects.

In an exemplary embodiment, the weapon system produces a lethal force. In another exemplary embodiment, the weapon system produces a non-lethal force, including any one of: a non-lethal laser signal; a non-lethal radar signal; and a non-lethal acoustic signal.

In an exemplary embodiment, the one or more sensed objects may be enemy combatants.

The GUI system may be responsive to any one of: the user selected sensor system input and the user selected weapon system input. Any one of: the user selected sensor system input, and the user selected weapon system input, may include any one of: a touch-screen input, a mouse input, and a keyboard input.

In an exemplary embodiment, an inertial navigation system may be used for providing a location of the mobile object. In an exemplary embodiment, a global positioning system (GPS) based navigation system for providing a location of the mobile object may be used.

The GUI system may display the coordinates of the mobile object. The GUI system may also display the coordinates of the one or more sensed objects.

In an exemplary embodiment, the method may further include recording a video of the one or more sensed objects. The video recording may be rewound and the GUI system may display the one or more sensed objects during a replay of a segment of the video recording.

In an exemplary embodiment, a machine-readable medium that provides instructions is disclosed, which when executed by a computing platform, causes the computing platform to perform operations comprising a method. The method may be for integrating a sensor system data and a weapon system data with a graphical user interface (GUI) system of a mobile object. The method may include: displaying an area surrounding the mobile object on the GUI system; determining the respective locations of one or more sensed objects sensed by the sensor system in the area in response to a user selected sensor system input; displaying the one or more sensed objects on the GUI system; and targeting the weapon system upon the one or more sensed objects in response to a user selected weapon system input.

Further features and advantages of, as well as the structure and operation of, various embodiments, are described in detail below with reference to the accompanying drawings.

### DETAILED DESCRIPTION OF THE EMBODIMENTS

Various exemplary embodiments are discussed in detail below including a preferred embodiment. While specific implementations are discussed, it should be understood that this is done for illustration purposes only. A person skilled in the relevant art can recognize that the systems, methods and features provided herein may be used without parting from the spirit and scope of the invention. Furthermore, any and all references cited herein shall be incorporated herein by reference in their respective entireties.

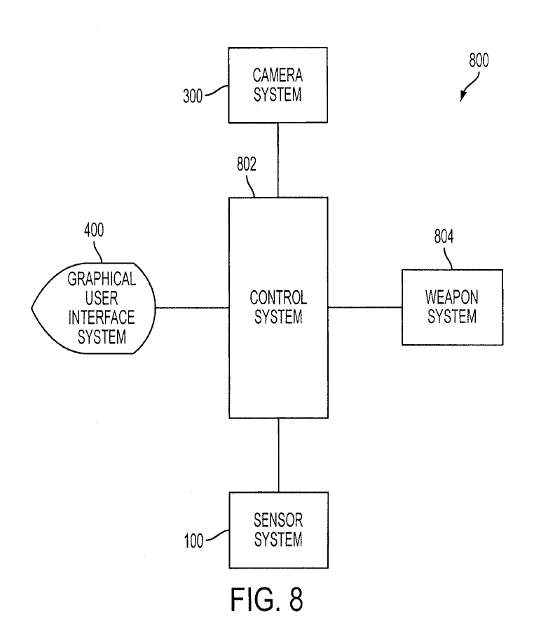

FIG. 8 illustrates an exemplary environment 800. Environment 800 provides an exemplary embodiment of a control system 802 that may be used in association with, in connection with, and/or in place of certain embodiments.

As illustrated, environment 800 may include control system 802, camera system 300, weapon system 804, sensor system 100, and graphical user interface (GUI) system 400. In an exemplary embodiment, control system 802 receives and/or transmits signals from any one of control system 802, camera system 300, weapon system 804, sensor system 100, and GUI system 400. Signals received by control system 802 may provide input data or parameters from one or more of the foregoing systems, which may be processed by control system 802.

In an exemplary embodiment, in response to received input data or parameters, control system 802 may be tasked to run one or more instructions, algorithms, or processes. In addition, control system 802 may be actuated to receive control instructions from a computer system and/or human user. In response, control system 802 may transmit output data or parameters to effect actions by of the camera system 300, weapon system 804, sensor system 100, and GUI system 400.

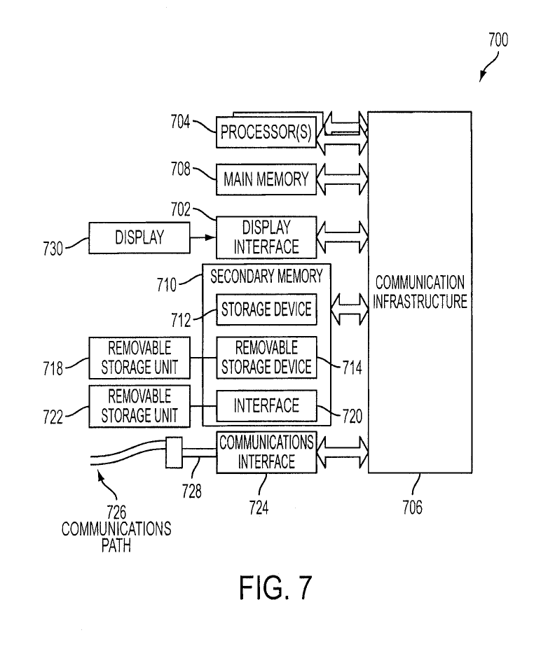

Furthermore, any of the illustrated systems, including control system 802, camera system 300, weapon system 804, sensor system 100, and GUI system 400, may comprise or employ one or more processing and communications systems and methods. For example, in an exemplary embodiment any of control system 802, camera system 300, weapon system 804, sensor system 100, and GUI system may comprise or employ any of the methods and systems described below in reference to the exemplary processing and communications embodiments of computer system 700 of FIG. 7.

In an exemplary embodiment, the control system 802 may be capable of detecting and/or calculating the position, velocity or acceleration of a vehicle or objects external from the vehicle based on input from sensor system 100. These operations, which are further described below, may be performed in any type of coordinate system. Additionally, control system 802 may perform a transform between any two or more of these coordinate systems, as further described below.

The control system 802 systems may be further described in view of the following exemplary embodiments.

### Exemplary Sensor System Embodiments

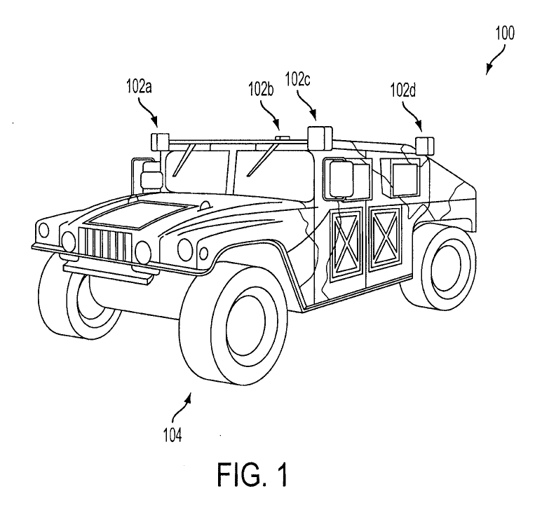

Beginning with FIG. 1, exemplary sensor system 100 is illustrated. In particular, the figure illustrates an exemplary military vehicle 104 equipped with exemplary sensor system 100 according to an exemplary embodiment. However, military vehicle 104 is provided for exemplary purposes only, as the present embodiments are not limited to military vehicles or vehicles.

In an exemplary embodiment, military vehicle 104 may be any vehicle that provides limited vision of the surroundings to its personnel, such as, but not limited to, high mobility multipurpose wheeled vehicle (HMMWV or Humvee), tanks, Strykers, etc. However, the system of the present embodiments may be extended to any moving vehicle or stationary enclosure. For example, the system of the present embodiments may be extended to any moving vehicle or stationary enclosure where awareness of the surroundings and the ability to react to situations instantaneously may be desirable.

Military vehicle 104 may be provided with sensor system 100, which may include one or more sensors for detection of the origins of unfriendly fire such as, but not limited to, a sniper hiding at a remote distance from vehicle 104.

In an exemplary embodiment, sensor system 100 and/or control system 802 may comprise an acoustic system, such as a gunfire detection system. For example, sensor system 100 and/or control system 802 may comprise the PDCue® Acoustics Gunfire Detection System, which may be utilized to detect the location of an enemy sniper.

The PDCue® Acoustics Gunfire Detection System is disclosed in U.S. Pat. Nos. 5,241,518; 5,544,129; and 6,563,763. The foregoing documents are all of common inventor and common assignee herewith, and are incorporated herein by reference in their respective entireties.

The exemplary PDCue® Acoustics Gunfire Detection System may include sensor system 100 comprising a number of spaced-apart transducers 102a, 102b, 102c and 102d. In an exemplary embodiment, these transducers are arranged to detect the direction of an enemy shot being fired at vehicle 104 based on the blast wave generated by the enemy propellant.

The transducers 102a-102d, as depicted herein, may be arranged at the four corners of the vehicle 104 to accurately detect the blast wave of the enemy propellant from any direction.

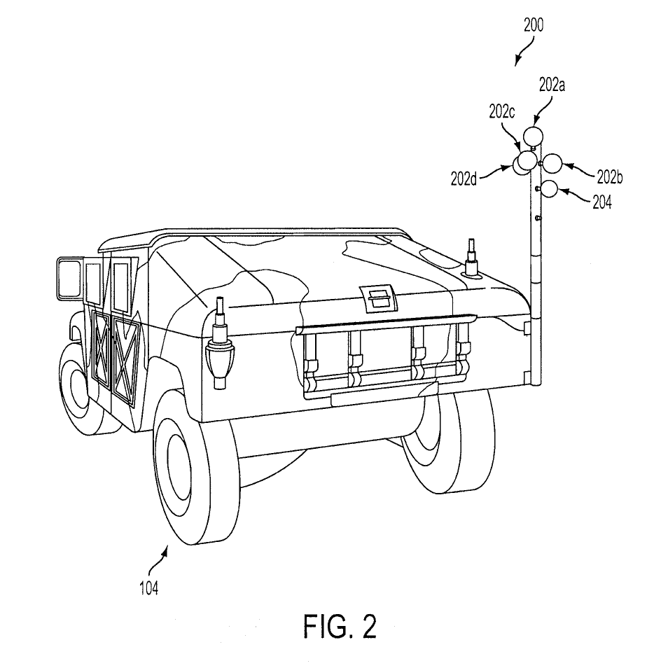

In an alternative embodiment of sensor system 100, labeled 200, as depicted in FIG. 2, a tetrahedral array arrangement of the transducers 201-202d mounted on a pole 204 on a rear corner of vehicle 104 may be adopted. The PDCue® Acoustics Gunfire Detection System may accordingly calculate the location, including the azimuth, range, and elevation of the enemy. It should be noted that sensor systems 100, 200, and any other types of sensor systems are generically referred to in the exemplary embodiments herein as sensor system 100.

In an exemplary embodiment, the bullet fired travels faster than the speed of sound, perhaps on the order of three times the speed of sound. Therefore, the shock wave created by the bullet as it passes near transducers 102a-102d may be received more quickly than sound of the muzzle blast as the bullet leaves the sniper's gun.

For example, at time t=t₀, the sniper's shot may be fired. At time t=t₁, the shock wave of the enemy bullet may be detected by the transducers 102a-102d. This shock wave may be referred to as the “crack.” At time t=t₂, the sound of the bullet as it leaves the muzzle of the sniper's gun, traveling at or near the speed of sound, may be detected by the transducers 102a-102d. The latter shock wave may be referred to as the “bang.”

In an exemplary embodiment, control system 802 includes an algorithm that determines and/or approximates the type of rifle or class of rifles based on the characteristics of the crack received at t₁. Control system 802 may then determine the type of bullet or other rounds capable of or typically fired by the rifle or class of rifles. Based on the foregoing, control system 802 may accordingly determine the likely speed of the bullet fired by the sniper.

Furthermore, control system 802 may receive the bang from the muzzle of the sniper's rifle at time t₂. The bang may travel at or near the speed of sound, which may be compensated by additional parameters accounted for by control system 802, including the air temperature, humidity, pressure and density.

In addition, in this exemplary embodiment control system 802 may receive inputs from one or more navigation systems associated with vehicle 104. For example, the distance traveled, velocity, acceleration and/or positioning/orientation of vehicle 104 in one or more coordinate systems may be determined and transmitted to control system 802. Inertial navigation systems, including magnetometers, accelerometers and/or gyroscopes, and external systems, such as for example global positioning systems (GPS), are exemplary systems employed to provide the velocity and positioning of exemplary vehicle 104.

Based on the crack, bang and/or velocity and positioning of vehicle 104, control system 802 may determine the distance from vehicle 104 to the sniper. In an exemplary embodiment, this distance is referred to as the range of the external object, namely for example, the sniper in the present embodiment. Control system 802 may readily determine the position of the sniper in one or more coordinate systems based on the range. An exemplary method and corresponding system for such detection is disclosed in the foregoing U.S. Pat. No. 6,563,763.

The present sensor systems embodiments, including the embodiments of sensor systems 100 and 200, are not limited to the above acoustic weapon detection system. In alternative embodiments, other types of sensors and corresponding systems and methods may be used to detect and/or estimate the location of a party, such as for example an enemy or hostile. Exemplary such systems, including corresponding methods, may include, but are not limited to, systems which sense or detect various forms of electromagnetic waves.

For example, visible light sensors (such as cameras), radar sensors, infrared (IR) sensors, and microwave sensors are but merely examples of alternative sensor systems 100 which may be employed. For example, radar or laser systems may be capable of detecting the location of an external object, such as an enemy sniper, and IR sensors may be capable of calculating the location of the enemy sniper based on the direction of IR signals being emitted from the enemy propellant. In addition, in alternative embodiments chemical sensors sensing one or more chemical agents may be used. In an exemplary embodiment, a combination of two or more different sensor systems 100 may be used for a more accurate estimation and detection.

Additional exemplary sensor systems 100 may include any systems and/or corresponding devices providing location detection capability, and working in coordination and/or cooperation with control system 802. These may include systems and/or method which provide information regarding vehicle 104, including for example, information corresponding to the location, relative position, acceleration, velocity and/or distance traveled by vehicle 104.

Exemplary such systems may include inertial navigation systems, including magnetometers, accelerometers and/or gyroscopes, for example, as well as external location detection systems, such as GPS. These exemplary sensor systems, working in coordination and/or cooperation with control system 802, may also include systems and/or methods which provide similar information regarding external objects, such as for example the systems and/or methods used to detect an enemy sniper as above described.

In an exemplary embodiment, the control system 802 may be capable of detecting and/or calculating the position, velocity or acceleration of an exemplary vehicle 104 or objects external from vehicle 104 based on input from sensor system 100. These operations, which are further described below, may be performed in any type of coordinate system.

Exemplary coordinate systems include rectilinear, polar, cylindrical and spherical coordinate systems. Additionally, control system 802 may perform a transform between any two or more of these coordinate systems.

For example, in a rectilinear coordinate system, straight lines are used to characterize each of the three dimensions. One rectilinear coordinate system which may be used with the present embodiments maps a three dimensional image camera image (for example, a fisheyed image) to a two dimensional visual display image. Here, the x-axis represents the azimuth. The difference in elevation between the leftmost portion of the screen and the rightmost portion of the screen is 180 degrees, or its equivalent in radians. For example, the center of the display may represent zero degrees, the leftmost portion of the display may represent −90 degrees, and the rightmost portion of the display may represent +90 degrees. The y-direction may represent the elevation. Similarly the difference in elevation between the lowermost portion of the screen and the uppermost portion of the screen may be 180 degrees, or its equivalent in radians.

Additional coordinate systems, and transformation between them, may also be used with various embodiments. An exemplary coordinate system, used with the present embodiments, may be a North-Earth coordinate system, where the x-axis comprises an axis pointing North, the y-axis comprises an axis pointing East, and the z-axis comprises an axis pointing to the earth's center.

Another exemplary coordinate system, used with the present embodiments, may be a vehicle-fixed coordinate system, where the x-axis comprises an axis extending from the front of an object, the y-axis comprises an axis extending from the right of an object, and the z-axis comprises an axis extending downward from the object.

Another exemplary coordinate system, used with the present embodiments, may be calculating-triangle reference frame, where x-points along the line from a first vehicle position to a second vehicle position, the y-axis is perpendicular to the x-axis and points out to the right in the triangular plane, and the z-axis is the downward normal to the triangle.

Control system 802 may also determine or calculate the position of the vehicle 104 or an external object. For example, in an exemplary embodiment, roll refers to a rotation of the object about the x-axis, pitch refers to a rotation of the object about the y-axis, and yaw refers to a rotation of the object about the z-axis.

### Exemplary Weapon System Embodiments

In exemplary embodiments, control system 802 may control one or more weapon systems 804 (not shown in FIG. 1). Any type of weapon systems and peripheral processes may be employed.

In an exemplary embodiment, control system 802 may control lethal weapons systems. These may include any type of known or conceived lethal weapons. Examples may include machine gun systems, tank gun systems and missile launching systems.

In an exemplary embodiment, control system 802 may control active denial weapons. Exemplary active denial weapons include weapons capable of providing non-lethal force upon an enemy combatant.

An exemplary such non-lethal control system 804 generates and launches a non-lethal laser at a target. The non-lethal laser may temporarily blind the targets, or invoke uncomfortable stimuli, such as the target's vomiting reflex.

Another exemplary such non-lethal control system 804 generates and launches non-lethal radar waves at a target. The non-lethal radar may cause such temporary symptoms as skin irritation and burning.

Another exemplary such non-lethal system 804 generates and launches extremely loud noises that may be pin-pointed directly at a target. The non-lethal loud noises may cause such temporary symptoms as temporary deafening or other discomfort.

In exemplary embodiments, control system 804 may engage any of the foregoing weapons by detecting and/or calculating the position, velocity or acceleration of a vehicle 104 or objects external from vehicle 104 based on the input from sensor system 100. Control system 804 may perform or control these operations based upon any of the foregoing methods/systems, in relation to any of the foregoing types of coordinate systems, including transformations between any two or more of these coordinate systems.

### Exemplary Camera System Embodiments

An exemplary type of sensor system 100 which may be used with the present embodiments includes a camera system 300. In exemplary embodiments, camera system 300 may be controlled by control system 802.

Exemplary camera system 300 may include cameras 302, 304, respectively corresponding to housing assemblies 306, 312. In an exemplary embodiment, each of the cameras 302, 304 comprises a day-night vision device. In an exemplary embodiment, each housing assembly, whose dimensions for an exemplary embodiment are illustrated, may include one or more processors whose features and functions may comprise any or all of the features and functions of control system 802.

In the exemplary embodiment illustrated, camera housing assemblies 306, 312 may respectively include fastening assembly pairs 318, 316 for fastening two or more subcomponents of the assemblies. Camera housing assemblies 306, 312 may also respectively include pivoting fasteners 308, 310, which may respectively pivotally mount housing assemblies 306, 312 to adjustable planes, to control the angles of the devices.

Housing 314 may house one or more power supplies for the devices and/or communications converters. In an exemplary embodiment, the converters respectively comprise video-to-gigabyte Ethernet converters. The two cameras 302, 304 may also be arranged, for example, but not limited to, at a 90° angle from one another.

In an exemplary embodiment, exemplary cameras 302, 304 may be used either in the front or the back of the vehicle 104. In an exemplary embodiment, a pair of the camera systems 300 are used, one facing the front of exemplary vehicle 104 and another facing the rear of vehicle 104.

Any types of images may be derived by the camera systems. For example, an exemplary embodiment the images of cameras 302, 304 and the processors of housing assemblies 306, 312, which may include the features/functions of control system 802, may comprise fisheyed images. In another exemplary embodiment, the images of cameras 302, 304 and the processors of housing assemblies 306, 312, which may include the features/functions of control system 802, may comprise rectilinear images.

The images of any of cameras 302, 304, of camera system 300, facing the front of exemplary vehicle 104, and the images of complementary cameras of another camera system 300, similarly situated in the rear of vehicle 104, may be combined together, either in processors of housing assemblies 306, 312, which may include features/functions of control system 802, or in a device or devices comprising a separate control system 802. The combining of images may be performed in any fashion, including through warping of the images or stitching together of separate images.

In an exemplary embodiment, the images obtained from two or more of the cameras, namely cameras 302, 304 facing the front of vehicle 104, and/or corresponding cameras facing the rear of vehicle 104, may be combined together to provide a complete frontal view of vehicle 104, a complete rear view of vehicle 104, or a combined frontal and rear view (360 degree view) of vehicle 104, as further described below with reference to GUI system 400.

### Exemplary Graphical User Interface System Embodiments

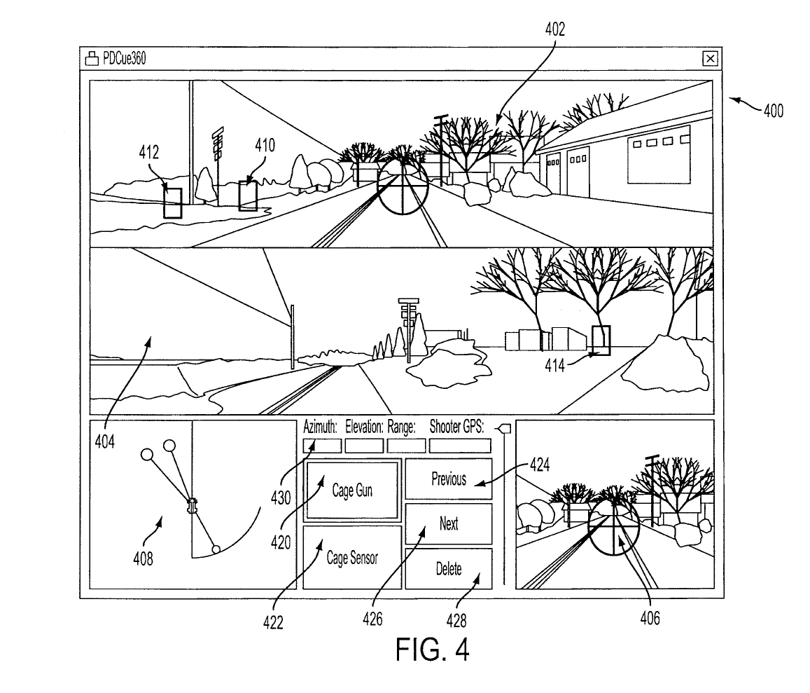

In exemplary embodiments, as depicted in FIG. 4, vehicle 104 may be provided with a graphical user interface (GUI) system 400. The GUI system 400 may be provided, for example, in the interior of vehicle 104. In exemplary embodiments, camera system 300 may be controlled by control system 802.

In an exemplary embodiment, control system 802 may also couple GUI system 400 to camera system 300. For example, GUI system 400 may also be coupled through one or more processing units resident to GUI system 400 and/or camera system 300 and/or remote from these systems, such processing units comprising control system 802.

In one example, exemplary front and/or rear camera systems 300 may together provide a substantially complete 360° panoramic view of the surroundings to the vehicle personnel.

In an exemplary embodiment, instead of using the plurality of camera systems 300, as above described, a panoramic image (for example, a 360° panoramic image) or other image may be collected on one or more focal plane arrays, made up of one or more charge coupled device (CCD) cameras, through a single or multiple optics collection groups. The resulting image may be a perspective of the 360° horizontal surroundings, which may be fisheyed in certain areas due to the combination of images from the different camera. The vertical view may be, for example, but is not limited to, a 90° vertical window of the surroundings. In an exemplary embodiment, the process may be onerous if a real-time video is being generated.

In an exemplary embodiment, the image may be converted to a rectilinear perspective view, which may be easier to use by the vehicle personnel. The rectilinear image may then be presented as either one continuous 360° panel or, for example, two panels, one of the front 180° field-of-view (FOV) and a second panel of the rear 180° FOV.

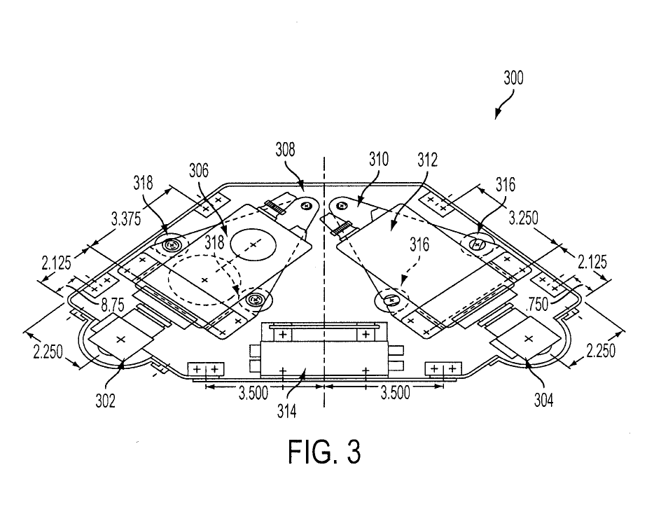

In an exemplary embodiment, multiple cameras may be used to generate the images for the GUI, as previously described with reference with FIG. 3. In an exemplary embodiment, the images from the four cameras may be combined together to generate a single 360° image on a single display panel. Alternatively, the images from the two front cameras and the two rear cameras are combined, respectively, to generate two images on two display panels.

As shown in FIG. 4, the front display panel 402 may provide a full image of the front of exemplary vehicle 104, which may be but is not limited to approximately 180°. Similarly, the rear display panel 404 may provide a full image of the rear of exemplary vehicle 104, which may be but is not limited to approximately 180°. In an exemplary embodiment, each panel display may be wider than 180° such that there is some overlap on the top and bottom display panels. For example, each of the display panels may provide a 200° display, such that a target perpendicular to the right or the left of vehicle 104 may be visible on both display panels.

Depending on the number of cameras used, the same fisheye problem may occur. However, in an exemplary embodiment, where at least two cameras are used for each display panel, rectilinear lenses may be used to present a good rectilinear image to each camera focal plane array. In an exemplary embodiment, fisheyed perspective images obtained from each camera of exemplary camera system 300 may then be converted to rectilinear perspective images in image post-processing.

In an exemplary embodiment, GUI system 400 may also be coupled through one or more processing units resident to GUI system 400 and/or sensor system 100 and/or remote from these systems, such processing units comprising control system 802. In an exemplary embodiment using rectilinear coordinates, the sensors may detect the location, including azimuth, elevation, and range of the enemy combatant, and provide the GUI system 400 with that information.

The GUI system 400 may then provide an indicator on the display panels, representing the location of the enemy combatant. For example, each of the rectangles 410, 412 and 414 may represent locations detected by the one or more of the sensor systems 100 described above.

In an exemplary embodiment, the rectangles 410, 412, and 414 may flash in given colors, for example, in white and red colors, to draw the attention of the operator. In an exemplary embodiment, the targets detected by the different sensors may be represented by different shapes, or other differing characteristics as well. For example, the targets detected by the acoustics sensor may be represented by a rectangle, whereas targets detected by the infrared sensor may be represented by an oval. In another example, the sizes of the shapes may provide meaning to the operator or control system 802 as well. For example, the size of exemplary rectangles and/or ovals may respectively characterize the relative accuracy with which the location of an exemplary sniper is known, with a smaller shape indicating that the location o the sniper is known with greater accuracy.

In exemplary embodiments, any types of input devices may be used for detecting inputs by the operator, and transmitting relevant parameters or other date to control system 802. In an exemplary embodiment, GUI system 400 may be a touch-screen display unit that allows the operator to select a target by touching the screen. Other types of displays coupled to input units such as a mouse or a keyboard may also be used.

In an exemplary embodiment, a third display panel 406 may also be provided. Display panel 406 may provide a zoomed-in view of an exemplary target. In an exemplary embodiment, the display panel 406 may provide a zoomed-in view of the front of the exemplary vehicle 104 by default. Once a target is selected by the operator, however, the display panel 406 may zoom in the area surrounding the target.

In an exemplary embodiment, the operator may select any area on the top panel 402 or the rear panel 404 and the surroundings of the selected area may be displayed on the display panel 406. In an exemplary embodiment, a zoom control (not shown) may also be provided to allow the operator to zoom in and out of the image displayed in the display panel 406.

In an exemplary embodiment, control system 802 may also couple GUI system 400 to weapon system 804. For example, GUI system 400 may also be coupled through one or more processing units resident to GUI system 400 and/or weapon system 804 and/or remote from these systems, such processing units comprising control system 802.

The weapon system 802 may include one or more of the aforementioned weapons. For example, weapon system 802 may include a gun provided on vehicle 104.

In an exemplary embodiment, a target is selected by the operator on the GUI system 400. The selection provides an input to control system 802. In turn, control system 802 either trains the weapon system 804 upon the target, or permits the operator to control the firing of ammunition toward the target. One or more of these processes may also be automated by control system 802.

In the illustrated example, the operator may cage the weapon system 804 on the target by pressing the “Cage Gun” button 420. In an exemplary embodiment, the control system 802 may then provide the guns with the relevant location of the target. For example, if rectilinear coordinates are being used, the location of the target may be provided in azimuth, elevation, and range. In an exemplary embodiment, any robotics system may be used to position the gun at the correct angle to aim at the target. The operator may then fire at the target.

In an exemplary embodiment, GUI system 400 may be coupled to a weapon system 804 comprising multiple guns, and provide the operator with a selection of the guns to choose from. The operator may then select a gun or guns, which may then point to the target as directed by the control system 802.

The components of exemplary sensor system 100 may be focused in a similar fashion. Certain types of sensor systems 100 may provide detection in 360°. For example, the aforementioned acoustic detection systems may provide such detection in 360°. Other types of sensor systems 100 may provide detection capability within a narrower range, and would therefore be necessary or desirable to focus these sensor systems 100 in a particular range of degrees surrounding the vehicle. For example, in an exemplary embodiment the IR sensors are capable of detection IR radiation within the confines of a +/−60° range.

Accordingly, in an exemplary embodiment there may also be provided a “Cage Sensor” button 422, which may direct one or more of the sensor systems 100 to focus more particularly on the target, for example, within the confines of a given azimuth and elevation in rectilinear coordinates. In an exemplary embodiment, control system 802 may provide sensor system 100 with control information regarding, e.g., the azimuth, elevation, and range of the target to focus on. This will allow the sensor system 100 to more accurately detect the location of the enemy combatant when, for example, a second shot is fired from the enemy combatant.

In an exemplary embodiment, location information 430 may also be provided by the control system 802 to the operator, and vice versa. For example, in an exemplary embodiment using rectilinear coordinates, azimuth, elevation, and range information may be provided on the display.

In an exemplary embodiment, there may also be provided a “Previous” button 424, a “Next” button 426, and a “Delete” button 428. For example, when multiple targets are identified, the operator may use the Previous button 424 to browse through previous targets (and/or corresponding video frames) in a stored list of targets, or the Next button 426 to browse the next targets (and/or corresponding video frames) in the list, or the Delete button 428 to delete any of the targets (and/or corresponding video frames) considered to be undesired or where action upon them has been completed.

In an exemplary embodiment, as previously described, the two cameras comprising a camera system 300 may be located at a 90° from each other and the lenses of the cameras may be, for example, approximately 1 foot apart. To demonstrate the point, supposing each camera may provide an image covering approximately to a 105° range. Thus, when the two images are combined into a single image, there may be an overlap area in the combined image. In an exemplary embodiment, the distance between the cameras may cause a parallax problem, which may refer to the change of angular position of two images taken by two cameras of a single object. In other words, due to the distance between the two cameras, an object located within the overlap area may not be at the same exact relative location to the two cameras. Accordingly, in an exemplary embodiment, instead of merging the overlapping area of the two images into one, the two images may be placed side by side and the overlapping area may be selected from one of the two cameras. Accordingly, if a target located on the right side of the top panel 402 is selected, the overlap area may be displayed using the right front camera, and when a target located on the left side of the top panel 402 is selected, the overlap area may be displayed using the left front camera.

In an exemplary embodiment, an additional display panel 408 may be provided which may provide a top view of the surroundings. In an exemplary embodiment, the display panel 408 may be generated using the information relating to the location of the various targets provided from the various sensor systems 100 as detected by control system 802. For example, the display panel 408 may display the targets detected via the acoustics sensor system. The display panel 408 may then switch to display the targets detected by another sensor, for example, the infrared sensor system, upon the operator clicking on the display panel 408.

In an exemplary embodiment, the display panel 408 may also generate images based on one or more navigation systems of the vehicle (not shown), which may provide parameters and other data to control system 802. The navigation system may include an inertial navigation system, which may comprise odometers, magnetometers, gyroscopes and the like, or an external navigation system, such as a GPS system, or a combination of the foregoing.

In an exemplary embodiment, the contents of the display panels 402, 404 and 408 may be updated based on real-time inertial data received from the cameras. As vehicle 104 moves, the target indicators may be locked on the target positions, so that the operators do not lose the target merely due to the movement of vehicle 104.

### Exemplary Video Replay Embodiments

In an exemplary embodiment, GUI system 400 may be coupled to a video processor system (not shown) controlled by control system 802. The video processor system may itself be coupled to an exemplary camera system 300 as above described. In an exemplary embodiment, the video processor system may include a surveillance processor that monitors the image and alerts the operator upon the occurrence of an event, such as for example, the appearance of a person in the image.

In an exemplary embodiment, the video processor may be adapted to focus on a particular display window within the entire image, which may be a display window close to and enclosing a target, and monitor the display window upon, for example, the appearance of an enemy combatant who may be hiding in the background. The video processor system may then create an alert to the operator or control system 802.

In exemplary embodiments, the video processor may also be used to track a person or location in the image. For example, if the operator believes a particular person in the surroundings to be suspicious, the video processor may be used to track and display that person in, for example, the display panel 406.

In many circumstances, after an enemy combatant, e.g., a sniper, has fired a shot at vehicle 104, the sniper may move or hide in a location near where the shot was fired. For example, the sniper may attempt to hide behind a wall of a building or disappear in the crowd.

Accordingly, in an exemplary embodiment, the GUI system 400 may be coupled to a video storage unit to provide a playback of the enemy combatant at the time the shot was fired. The video storage unit may include a buffer that may store the images being displayed on the front and rear display panels 402, 404, for a predetermined or in real-time determined period of time.

As noted above in the exemplary sensor system embodiments, numerous sensor systems may be employed to detect an activity, such as an enemy combatant firing a rifle at vehicle 104. For example, as described above an acoustic gunfire detection system may be employed where shock wave (“crack”) of the bullet grazing by acoustic detectors 102a-102d of vehicle 104 may be measured, as well as the later arriving sound of the bullet leaving the muzzle of the rifle (“bang”), in order to detect the location of the enemy sniper, and the likely time the sniper fired the bullet.

In exemplary embodiments, the video processor may be continually buffering the video frames from a given direction. The direction of the video camera and the time frame for buffering video may be predefined, or designated in real-time, either by the user or by control system 802. The video device may have captured a video recording of the sniper when the weapon was fired. The operator may designate control system 802 to play back the video, for example at display panel 406, to display the firing of the weapon or other activities desired to be monitored.

For example, suppose in an exemplary embodiment that an exemplary video processor captures and buffers 30 frames per second, such that in 5 seconds, 150 frames of video are buffered. Further suppose in the exemplary embodiment that the “crack” and “bang” of an acoustic sensor system, or for that matter any other type of sensor system, indicates that the bullet was fired 2.1 seconds earlier. The operator may designate one or more controls on the GUI, which in turn may elicit control system 802, to rewind and replay the buffered video for a period starting 3 or 4 seconds earlier, in display panel 406.

The activity may increase the situational awareness of the operator in relation to the enemy combatant. The operator may use the playback to view the location surrounding the target at the time the shot was fired, which may allow the operator to determine what the enemy combatant looks like or where the enemy combatant relocated to after the shot was fired. Accordingly, the operator may select a different area, for example, a short distance away from the identified target, where the vehicle weapon system 804 will be re-aimed.

### Exemplary Embodiments for Ranging Based on Pixel Shift and Velocity Input

As noted above in the exemplary sensor system embodiments, numerous differing types of sensor systems may be employed to detect the location of a third party object, such as an enemy combatant or sniper. For example, as described above an acoustic gunfire detection system may be employed where shock wave (“crack”) of the bullet detected by acoustic detectors 102a-102d of vehicle 104 may be measured, as well as the later arriving sound of the bullet leaving the muzzle of the rifle (“bang”), in order to detect the location of the enemy sniper.

Such detection systems, and accompanying methods, may not always be reliable. For example, if the enemy sniper uses a muzzle silencing mechanism, the “bang” associated with the bullet leaving the muzzle may be difficult or impossible to detect. On the other hand, environmental conditions may make detection of the shock wave “crack” of the bullet difficult or impossible. In fact, various environment conditions may make detection difficult or impossible for any of the above noted sensor systems 100.

In exemplary alternative embodiments, however, the location of the target may be calculated using the location and/or motion of the target being displayed on GUI system 400, as herein described. As vehicle 104 moves forward, the location of the target as identified by the sensors may move within the display from one pixel to another.

In an exemplary GUI system 400 using rectilinear coordinates, there may be a one-to-one correspondence between each pixel and each azimuth-elevation coordinate pair. Any feature or element displayed on GUI system 400 may be identified.

For example, a feature or element may be uniquely identified using any type of identification technique. An exemplary identification technique that may be used for objects is centroid homing. Another exemplary identification technique that may be used for detection of elements bearing numerous lines and edges is edge detection.

The feature or element may be tracked as it moves in the GUI system 400 display, from pixel to pixel, or from fractions of pixels to fractions of pixels. In fact, the movement on the GUI system 400 display may be caused by the movement of the vehicle 104 in relation to its surroundings.

For example, a target which is initially identified at a 45° angle on the front right display panel may move slowly to the right of the display panel as exemplary vehicle 104 moves forward. In an exemplary embodiment, the change in the position of the target through the screen pixels may be used to calculate the range of the target, meaning the distance to the target.

As noted, each pixel may be assigned a one-on-one correspondence to an azimuth-elevation angle. As vehicle 104 moves past the target, the target moves on the GUI system 400 display across different pixels.

Based on the speed of exemplary vehicle 104 and the rate at which the target moves from the origination pixel or pixels to the destination pixel or pixels, the range or distance between the target and exemplary vehicle 104 may be calculated. This pixel-shifting approach for calculating the range of the target may be according to the following exemplary embodiments.

In one exemplary embodiment, if the target is located within the overlap area of the two images, meaning at an angle close to the front or back of exemplary vehicle 104, the relative pixel location of the two images may be used via a process referred to as stereoscopic imaging. In an exemplary embodiment, the change in position in the right image may be compared to the change in the pixel position in the left image, which allows calculation of the range of the target.

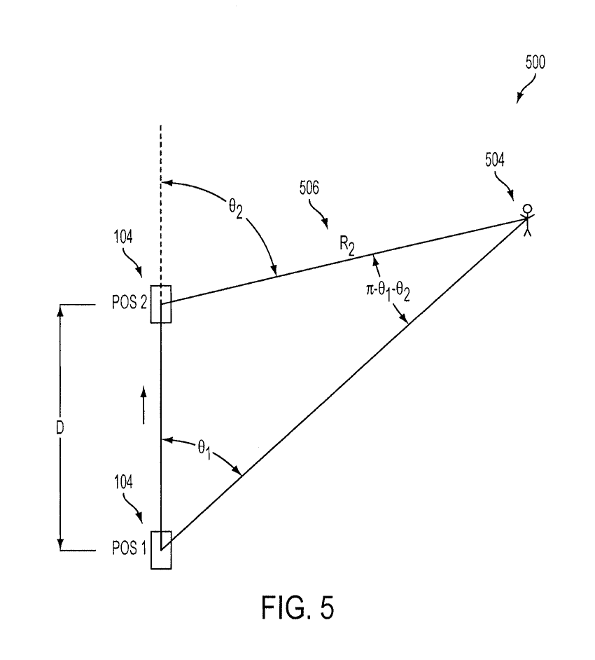

Exemplary pixel-shifting approaches for calculating the range of the target may be according to the following exemplary embodiments. FIG. 5 illustrates a first system 500. System 500 shows vehicle 104 moving from a first position (Pos 1) to a second position (Pos 2), separated by a distance D. It is desirable to determine the range R₂ of exemplary sniper 504 from Pos 2. In this illustration, the azimuth angle from Pos 1 to sniper 504 is denoted by θ₁, whereas the azimuth angle from Pos 2 to sniper 504 is denoted by θ₂.

In an exemplary embodiment, it may be assumed that there is no preexisting, or a priori knowledge, of range R₂ to the sniper 504 from vehicle 104 to the sniper. When vehicle 104 is at position 1, the sniper 504 may be seen on the display at a position corresponding to an azimuth angle of θ₁ and elevation angle of 0°. In fact, for this exemplary embodiment, it is assumed that the sniper is initially at elevation=0° and stays at that elevation. This implies that both positions of exemplary vehicle 104 and the position of the sniper 504 are on the same elevation and that vehicle 104 has no roll, pitch, or yaw (in aircraft coordinates) at either position.

Exemplary vehicle 104 may then move a straight line distance, D, from position 1 to a new position 2, where sniper 504 is seen on the display at an azimuth angle of θ₂ and elevation angle of 0°.

Here, the range, or distance from vehicle 104 to sniper 504 at position 2, labeled R₂, may be calculated from the Law of Sines as follows:

R₂/Sin(θ₁)=D/Sin(π−θ₁−θ₂), or

R₂=D·Sin(θ₁)/Sin(π−θ₁−θ₂)

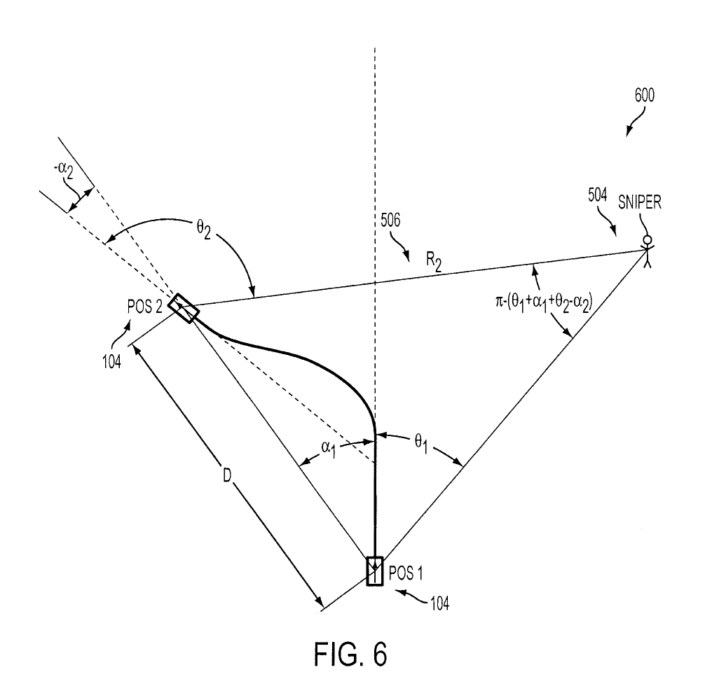

In an exemplary embodiment, a second example may be used to demonstrate a more general case for determination of the range R₂. This exemplary embodiment is illustrated in system 600 of FIG. 6.

In this second exemplary embodiment, from position 1 (Pos 1), vehicle 104 is illustrated to meander off the straight road at position 2 (Pos 2). This introduces a yaw angle in the vehicle 104 with respect to the straight line, D, from the vehicle 104 position 1 to the vehicle 104 position 2, as shown in FIG. 6.

Here θ₁ and θ₂ are still the azimuth angles from vehicle 104 respectively at the two positions (Pos 1, Pos 2) to sniper 504. These may be calculated by determining at what pixel in the display of the GUI system 400 the sniper center appears. In an exemplary embodiment, this calculation may be possible because every pixel in the rectilinear display uniquely corresponds to a different azimuth-elevation pair. As shown, the calculating triangle has at its three apexes the vehicle 104 position 1, vehicle 104 position 2, and the sniper position 504. However, in this example, the base angles, θ₁ and θ₂ of the first example above, are now modified by the yaw angles α₁ and α₂; and thus, become θ₁+α₁ and θ₂−α₂.

In an exemplary embodiment, the yaw angles and the distance traveled, D, can be calculated from inputs from a navigation system. For example, an inertial navigation unit may report vehicle position and vehicle roll, pitch, and yaw with respect to the North direction.

The Law of Sines then gives:

R₂=D·Sin(θ₁+α₁)/Sin(π−(θ₁+α₁+θ₂−α₂))

The calculation of range can further be complicated by introducing an altitude difference between the vehicle 104 positions (Pos 1, Pos 2) and the sniper location 504. In an exemplary embodiment, it can be assumed that the two vehicle position altitudes are very close to the same altitude because vehicle 104 may not translate very far during these incremental calculations of range. This range calculation can be updated, for example, at 10 times per second. For example, at 60 miles per hour, vehicle 104 will only translate 8.8 feet in 1/10th of a second. However, sniper 504 may be on the order of a mile away and therefore at a significantly different altitude.

In an exemplary embodiment, multiple coordinate systems (CS) may be used to solve for the range R₂. For example, three CSs may be used to correctly calculate triangle base angles: the first, a vehicle fixed system where the x-axis always points out the front of the vehicle, the y-axis points out the side of the vehicle, and the z-axis points through the floor of the vehicle; the second, a North-Earth fixed CS, where the x-axis points along North, the y-axis points East, and the z-axis points to the earth's center; and the third, a CS in the calculating-triangle reference frame, where x-points along the line from vehicle 104 position 1 to vehicle 104 position 2, the y-axis is perpendicular to the x-axis and points out to the right in the triangular plane, and the z-axis is the downward normal to the triangle.

It may be assumed, for example, that at position 1, sniper 504 is detected on a pixel that corresponds to an azimuth-elevation pair of (θ₁, ε₁) in the vehicle coordinate system. This is the sniper position relative to the vehicle.

Further, it may be assumed that the vehicle has a roll-pitch-yaw in the North-Earth CS of (ρ₁, σ₁, β₁). These angles may be read directly from an inertial sensor mounted in the vehicle. Similarly, it may be assumed that position 2 has the corresponding sets of angles of (θ₂, ε₂) and (ρ₂, σ₂, β₂).

It may also be assumed that there is a vector D which points from the first vehicle 104 position to the second vehicle 104 position. This can be calculated, for example, from the position coordinates of the two locations given by the exemplary navigation system. The angle that D makes to North, α₁, can then be calculated.

In this exemplary embodiment, it is desirable to know what the azimuth angle is in the CS of the calculating-triangle. It will be different than it is in the vehicle system.

Each (θ, ε) corresponds to a unit vector r₁, (bolding, here, indicates a vector quantity), with components (r₁ₓ, r_{1y}, r_{1z}) in the vehicle CS. In order to calculate range correctly, a rotational transform r₁ from the Vehicle CS to North-Earth CS (r₁′) may be performed, followed by a transform to the Calculating-Triangle CS (r₁″). Once in the Calculating-Triangle CS, the azimuth can be calculated from the components of r₁″. In the Calculating-Triangle CS, the elevation to the sniper may always be zero.

Rotational transformations may be accomplished using the 3 by 3 Euler transformation matrix M and its inverse MT:

$$M ( r , p , y ) = ( \begin{matrix}Cos [ p ] Cos [ y ] & Cos [ p ] Sin [ y ] & - Sin [ p ] \\ \begin{matrix}Cos [ y ] Sin [ p ] Sin [ r ] - \\ Cos [ r ] Sin [ y ]\end{matrix} & \begin{matrix}Cos [ r ] Cos [ y ] + \\ Sin [ p ] Sin [ r ] Sin [ y ]\end{matrix} & Cos [ p ] Sin [ r ] \\ \begin{matrix}Cos [ r ] Cos [ y ] Sin [ p ] + \\ Sin [ r ] Sin [ y ]\end{matrix} & \begin{matrix}- Cos [ y ] Sin [ r ] + \\ Cos [ r ] Sin [ p ] Sin [ y ]\end{matrix} & Cos [ p ] Cos [ r ]\end{matrix} )$$

$$and$$

$${M}^{- 1} ( r , p , y ) = ( \begin{matrix}Cos [ p ] Cos [ y ] & Cos [ y ] Sin [ p ] Sin [ r ] - & \begin{matrix}Cos [ r ] Cos [ y ] Sin [ p ] + \\ Sin [ r ] Sin [ y ]\end{matrix} \\ Cos [ p ] Sin [ y ] & \begin{matrix}Cos [ r ] Sin [ y ] \\ \begin{matrix}Cos [ r ] Cos [ y ] + \\ Sin [ p ] Sin [ r ] Sin [ y ]\end{matrix}\end{matrix} & \begin{matrix}- Cos [ y ] Sin [ r ] + \\ Cos [ r ] Sin [ p ] Sin [ y ]\end{matrix} \\ - Sin [ p ] & Cos [ p ] Sin [ r ] & Cos [ p ] Cos [ r ]\end{matrix} )$$

where r is roll around the x-axis, p is pitch around the y-axis, and y is yaw around the z-axis.

The components of r=(rₓ, r_{y}, r_{z}) can be expressed in terms of (θ, ε) as:

r=(sin(θ)cos(ε),sin(θ)sin(ε),cos(θ))

Step 1: From the Vehicle CS to the North-Earth CS using the inverse rotation matrix to undo vehicle roll=ρ₁, pitch=σ₁, and yaw=α₁:

r₁′=M⁻¹(ρ₁,σ₁,β₁)·r₁

Step 2: From the North-Earth CS to Calculating-Triangle CS by first using the inverse rotation matrix to heading yaw offset=α₁:

r₁″=M(0,0,α₁)·r₁′, or

r₁″=M(0,0,α₁)·M⁻¹(ρ₁,σ₁,β₁)·r₁

and then establishing the calculating-triangle roll ω necessary to rotate the CS into the calculating-triangle plane.

The angle ω may be just the angle calculated from tan(ω)=r_{1y}″/r₁ₓ″. This last roll may be finally rotated to yield:

r₁′″=M(ω,0,0)·r₁″, or

r₁′″=M(ω,0,0)·M(0,0,α₁)·M−1(ρ₁,σ₁,β₁)·r₁

Finally, the new azimuth angle θ1′″ is just the inverse cosine of r_{1z}′″, or

$$Cos ( {θ}_{1}^{′′′} ) = Cos [ ɛ ] Sin [ θ ] ( \begin{matrix}Cos [ {β}_{1} ] Cos [ {σ}_{1} ] Sin [ ω ] Sin [ {α}_{1} ] - \\ Cos [ {α}_{1} ] Cos [ {σ}_{1} ] Sin [ ω ] Sin [ {β}_{1} ] - \\ Cos [ ω ] Sin [ {σ}_{1} ]\end{matrix} ) + Cos [ θ ] ( \begin{matrix}Cos [ ω ] Cos [ {ρ}_{1} ] Cos [ {σ}_{1} ] + \\ Sin [ ω ] Sin [ {α}_{1} ] \\ ( \begin{matrix}Sin [ {β}_{1} ] Sin [ {ρ}_{1} ] + \\ Cos [ {β}_{1} ] Cos [ {ρ}_{1} ] Sin [ {σ}_{1} ]\end{matrix} ) - \\ Cos [ {α}_{1} ] Sin [ ω ] \\ ( \begin{matrix}- Cos [ {β}_{1} ] Sin [ {ρ}_{1} ] + \\ Cos [ {ρ}_{1} ] Sin [ {β}_{1} ] Sin [ {σ}_{1} ]\end{matrix} )\end{matrix} ) + Sin [ ɛ ] Sin [ θ ] ( \begin{matrix}Cos [ ω ] Cos [ {σ}_{1} ] Sin [ {ρ}_{1} ] + \\ Sin [ ω ] Sin [ {α}_{1} ] \\ ( \begin{matrix}- Cos [ {ρ}_{1} ] Sin [ {β}_{1} ] + \\ Cos [ {β}_{1} ] Sin [ {ρ}_{1} ] Sin [ {σ}_{1} ]\end{matrix} ) - \\ Cos [ {α}_{1} ] Sin [ ω ] \\ ( \begin{matrix}Cos [ {β}_{1} ] Cos [ {ρ}_{1} ] + \\ Sin [ {β}_{1} ] Sin [ {ρ}_{1} ] Sin [ {σ}_{1} ]\end{matrix} )\end{matrix} )$$

A similar calculation can be performed for vehicle 104 at position 2, and once θ1′″ and θ2′″ are found, the values may be fed into the above equation as follows to yield the range:

R₂=D·Sin(θ1′″)/Sin(π−θ1′″−θ2′″).

### Exemplary Processing and Communications Embodiments

FIG. 7 depicts an exemplary embodiment of a computer system 700 that may be used in association with, in connection with, and/or in place of, but not limited to, any of the foregoing components and/or systems.

The present embodiments (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 700 is shown in FIG. 7, depicting an exemplary embodiment of a block diagram of an exemplary computer system useful for implementing the present invention. Specifically, FIG. 7 illustrates an example computer 700, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/, etc. available from MICROSOFT® Corporation of Redmond, Wash., U.S.A., SOLARIS® from SUN® Microsystems of Santa Clara, Calif., U.S.A., OS/2 from IBM® Corporation of Armonk, N.Y., U.S.A., Mac/OS from APPLE® Corporation of Cupertino, Calif., U.S.A., etc., or any of various versions of UNIX® (a trademark of the Open Group of San Francisco, Calif., USA) including, e.g., LINUX®, HPUX®, IBM AIX®, and SCO/UNIX®, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 700 is shown in FIG. 7. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 7.

The computer system 700 may include one or more processors, such as, e.g., but not limited to, processor(s) 704. The processor(s) 704 may be connected to a communication infrastructure 706 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 700 may include a display interface 702 that may forward, e.g., but not limited to, graphics, text, and other data, etc., from the communication infrastructure 706 (or from a frame buffer, etc., not shown) for display on the display unit 730.

The computer system 700 may also include, e.g., but may not be limited to, a main memory 708, random access memory (RAM), and a secondary memory 710, etc. The secondary memory 710 may include, for example, (but not limited to) a hard disk drive 712 and/or a removable storage drive 714, representing a floppy diskette drive, a magnetic tape drive, an optical disk drive, a compact disk drive CD-ROM, etc. The removable storage drive 714 may, e.g., but not limited to, read from and/or write to a removable storage unit 718 in a well known manner. Removable storage unit 718, also called a program storage device or a computer program product, may represent, e.g., but not limited to, a floppy disk, magnetic tape, optical disk, compact disk, etc. which may be read from and written to by removable storage drive 714. As will be appreciated, the removable storage unit 718 may include a computer usable storage medium having stored therein computer software and/or data.

In alternative exemplary embodiments, secondary memory 710 may include other similar devices for allowing computer programs or other instructions to be loaded into computer system 700. Such devices may include, for example, a removable storage unit 722 and an interface 720. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 722 and interfaces 720, which may allow software and data to be transferred from the removable storage unit 722 to computer system 700.

Computer 700 may also include an input device such as, e.g., (but not limited to) a mouse or other pointing device such as a digitizer, and a keyboard or other data entry device (none of which are labeled).

Computer 700 may also include output devices, such as, e.g., (but not limited to) display 730, and display interface 702. Computer 700 may include input/output (I/O) devices such as, e.g., (but not limited to) communications interface 724, cable 728 and communications path 726, etc. These devices may include, e.g., but not limited to, a network interface card, and modems (neither are labeled). Communications interface 724 may allow software and data to be transferred between computer system 700 and external devices. Examples of communications interface 724 may include, e.g., but may not be limited to, a modem, a network interface (such as, e.g., an Ethernet card), a communications port, a Personal Computer Memory Card International Association (PCMCIA) slot and card, etc. Software and data transferred via communications interface 724 may be in the form of signals 728 which may be electronic, electromagnetic, optical or other signals capable of being received by communications interface 724. These signals 728 may be provided to communications interface 724 via, e.g., but not limited to, a communications path 726 (e.g., but not limited to, a channel). This channel 726 may carry signals 728, which may include, e.g., but not limited to, propagated signals, and may be implemented using, e.g., but not limited to, wire or cable, fiber optics, a telephone line, a cellular link, an radio frequency (RF) link and other communications channels, etc.

In this document, the terms “computer program medium” and “computer readable medium” may be used to generally refer to media such as, e.g., but not limited to removable storage drive 714, a hard disk installed in hard disk drive 712, and signals 728, etc. These computer program products may provide software to computer system 700. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

Computer programs (also called computer control logic), may include object oriented computer programs, and may be stored in main memory 708 and/or the secondary memory 710 and/or removable storage units 714, also called computer program products. Such computer programs, when executed, may enable the computer system 700 to perform the features of the present invention as discussed herein. In particular, the computer programs, when executed, may enable the processor 704 to provide a method to resolve conflicts during data synchronization according to an exemplary embodiment of the present invention. Accordingly, such computer programs may represent controllers of the computer system 700.

In another exemplary embodiment, the invention may be directed to a computer program product comprising a computer readable medium having control logic (computer software) stored therein. The control logic, when executed by the processor 704, may cause the processor 704 to perform the functions of the invention as described herein. In another exemplary embodiment where the invention may be implemented using software, the software may be stored in a computer program product and loaded into computer system 700 using, e.g., but not limited to, removable storage drive 714, hard drive 712 or communications interface 724, etc. The control logic (software), when executed by the processor 704, may cause the processor 704 to perform the functions of the invention as described herein. The computer software may run as a standalone software application program running atop an operating system, or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

The exemplary embodiment of the present invention makes reference to wired, or wireless networks. Wired networks include any of a wide variety of well known means for coupling voice and data communications devices together. A brief discussion of various exemplary wireless network technologies that may be used to implement the embodiments of the present invention now are discussed. The examples are non-limited. Exemplary wireless network types may include, e.g., but not limited to, code division multiple access (CDMA), spread spectrum wireless, orthogonal frequency division multiplexing (OFDM), 1G, 2G, 3G wireless, Bluetooth, Infrared Data Association (IrDA), shared wireless access protocol (SWAP), “wireless fidelity” (Wi-Fi), WIMAX, and other IEEE standard 802.11-compliant wireless local area network (LAN), 802.16-compliant wide area network (WAN), and ultrawideband (UWB), etc.

Bluetooth is an emerging wireless technology promising to unify several wireless technologies for use in low power radio frequency (RF) networks.

IrDA is a standard method for devices to communicate using infrared light pulses, as promulgated by the Infrared Data Association from which the standard gets its name. Since IrDA devices use infrared light, they may depend on being in line of sight with each other.

The exemplary embodiments of the present invention may make reference to WLANs. Examples of a WLAN may include a shared wireless access protocol (SWAP) developed by Home radio frequency (HomeRF), and wireless fidelity (Wi-Fi), a derivative of IEEE 802.11, advocated by the wireless Ethernet compatibility alliance (WECA). The IEEE 802.11 wireless LAN standard refers to various technologies that adhere to one or more of various wireless LAN standards. An IEEE 802.11 compliant wireless LAN may comply with any of one or more of the various IEEE 802.11 wireless LAN standards including, e.g., but not limited to, wireless LANs compliant with IEEE std. 802.11a, b, d or g, such as, e.g., but not limited to, IEEE std. 802.11 a, b, d and g, (including, e.g., but not limited to IEEE 802.11g-2003, etc.), etc.

Unless specifically stated otherwise, as apparent from the following discussions, it may be appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device. In yet another exemplary embodiment, the invention may be implemented using a combination of any of, for example, but not limited to, hardware, firmware and software, etc. References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Finally, while various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A system for integrating sensory data and weaponry data with a graphical user interface (GUI) system of a mobile object, comprising:
a camera system capturing an area surrounding the mobile object;
a sensor system capturing the respective locations of one or more sensed objects in the area surrounding the mobile object in response to a user selected sensor system input;
a weapon system targeting the one or more sensed objects in response to a user selected weapon system input; and
the GUI system displaying the area surrounding the mobile object and the one or more sensed objects in the area surrounding the mobile object.

2. The system according to claim 1, wherein the mobile object comprises a military vehicle.

3. The system according to claim 2, wherein the military vehicle comprises any one of: a high mobility multipurpose vehicle (HMMWV); a tank; and an eight-wheeled all-wheel-drive armored combat vehicle.

4. The system according to claim 1, wherein the camera system comprises a first camera system assembly displaying a front portion of the surrounding area of the mobile object, and a second camera system assembly displaying a rear portion of the surrounding area of the mobile object.

5. The system according to claim 1, wherein the sensor system comprises at least one of: an acoustic detection system; an infrared (IR) detection system; a visible light detection system; a radar detection system; a microwave detection system; and a chemical detection system.

6. The system according to claim 1, wherein the weapon system comprises a lethal force producing weapon system.

7. The system according to claim 1, wherein the weapon system comprises a non-lethal force producing weapon system, comprising any one of: a non-lethal laser system; a non-lethal radar system; and a non-lethal acoustic system.

8. The system according to claim 1, wherein the one or more sensed objects comprise enemy combatants.

9. The system according to claim 1, wherein the GUI system is responsive to any one of: the user selected sensor system input and the user selected weapon system input.

10. The system according to claim 9, wherein any one of: the user selected sensor system input, and the user selected weapon system input, comprises any one of: a touch-screen input, a mouse input, and a keyboard input.

11. The system according to claim 1, further comprising an inertial navigation system for providing a location of the mobile object.

12. The system according to claim 1, further comprising a global positioning system (GPS) based navigation system for providing a location of the mobile object.

13. The system according to claim 1, wherein the GUI system displays the coordinates of the mobile object.

14. The system according to claim 1, wherein the GUI system displays the coordinates of the one or more sensed objects.

15. The system according to claim 1, further comprising a video recording system recording a video of the one or more sensed objects.

16. The system according to claim 15, wherein the video recording system rewinds the video recording and the GUI system displays the one or more sensed objects during a replay of a segment of the video recording.

17. A method for integrating a sensor system data and a weapon system data with a graphical user interface (GUI) system of a mobile object, comprising:
displaying an area surrounding the mobile object on the GUI system;
determining the respective locations of one or more sensed objects sensed by the sensor system in the area in response to a user selected sensor system input;
displaying the one or more sensed objects on the GUI system; and
targeting the weapon system upon the one or more sensed objects in response to a user selected weapon system input.

18. The method according to claim 17, wherein the area surrounding the mobile object is sensed by a camera system.

19. The method according to claim 16, wherein the area surrounding the mobile object comprises any one of: a 180 degree panoramic view of the front of the mobile object; a 180 degree panoramic view of the rear of the mobile object; and a 360 degree panoramic view of the surroundings of the mobile object.

20. The method according to claim 17, wherein the sensor system detects at least one of: an acoustic signal associated with the sensed objects; an infrared (IR) signal associated with the sensed objects; a visible light signal associated with the sensed objects; a radar signal associated with the sensed objects; a microwave signal associated with the sensed objects; and a chemical signal associated with the sensed objects.

21. The method according to claim 17, wherein the weapon system produces a lethal force.

22. The method according to claim 17, wherein the weapon system produces a non-lethal force, comprising any one of: a non-lethal laser signal; a non-lethal radar signal; and a non-lethal acoustic signal.

23. The method according to claim 17, wherein the one or more sensed objects comprise enemy combatants.

24. The method according to claim 17, wherein the GUI system is responsive to any one of: the user selected sensor system input and the user selected weapon system input.

25. The method according to claim 24, wherein any one of: the user selected sensor system input, and the user selected weapon system input, comprises any one of: a touch-screen input, a mouse input, and a keyboard input.

26. The method according to claim 17, using an inertial navigation system for providing a location of the mobile object.

27. The method according to claim 17, further comprising using a global positioning system (GPS) based navigation system for providing a location of the mobile object.

28. The method according to claim 17, wherein the GUI system displays the coordinates of the mobile object.

29. The method according to claim 17, wherein the GUI system displays the coordinates of the one or more sensed objects.

30. The method according to claim 17, further comprising recording a video of the one or more sensed objects.

31. The method according to claim 30, wherein the video recording is rewound and the GUI system displays the one or more sensed objects during a replay of a segment of the video recording.

32. A machine-readable medium that provides instructions, which when executed by a computing platform, causes the computing platform to perform operations comprising a method for integrating a sensor system data and a weapon system data with a graphical user interface (GUI) system of a mobile object, the method comprising:
displaying an area surrounding the mobile object on the GUI system;
determining the respective locations of one or more sensed objects sensed by the sensor system in the area in response to a user selected sensor system input;
displaying the one or more sensed objects on the GUI system; and
targeting the weapon system upon the one or more sensed objects in response to a user selected weapon system input.
